(19) United States
(12) Patent Application Publication
(10) Pub. No.: US 2014/0053541 A1
(43) Pub. Date: Feb. 27, 2014

(54) VEHICLE ENERGY STORAGE SYSTEM AND METHOD OF USE

(71) Applicants: Adam Timmons, Birmingham, MI (US); Steven L. Clark, Birmingham, MI (US)

(72) Inventors: Adam Timmons, Birmingham, MI (US); Steven L. Clark, Birmingham, MI (US)

(73) Assignee: CHRYSLER GROUP LLC, Auburn Hills, MI (US)

(21) Appl. No.: 13/593,559

(22) Filed: Aug. 24, 2012

(51) Int. Cl. B60K 6/12; B60K 6/20; F15B 1/027

(52) U.S. Cl. 60/327; 60/407

(57) ABSTRACT

Methods and systems for using compressed gas in a vehicle. The methods include generating mechanical energy by expanding stored compressed gas through a turbine-compressor and distributing the mechanical energy to the engine, motor-generator, or a wheel. The compressed gas vehicle system includes a flask connected to a turbine-compressor, which may be interconnected to the engine and the motor-generator. The system may also include an electric wheel-motor connected electrically to the motor-generator.

### FIELD

The present disclosure relates generally to engine systems and control and particularly to vehicle power conversion and storage.

### BACKGROUND

Presently, the fuel economy of internal combustion engines can be improved by using stop-start systems wherein the engine is shut down automatically when not needed for acceleration or other tasks. Such stopping cycles may occur while decelerating or when the vehicle would otherwise be at rest and idling.

However, stored energy is needed to restart the engine and, in the case of electrified power train systems, momentarily accelerate the vehicle. Traditionally, this energy is released from electrochemical storage cells (batteries) to facilitate a few seconds of combined acceleration and engine restart. Batteries have a limited life. Accordingly, there is room for improvement in the art.

### SUMMARY

In various example embodiments, the present disclosure provides methods and systems for using compressed gas in a vehicle. The methods include generating mechanical energy by expanding a stored compressed gas through a turbine-compressor and distributing the mechanical energy to at least one vehicle component requiring power. The methods also include distributing the mechanical energy via a clutch.

One such embodiment includes using the mechanical energy to generate electricity via a motor-generator. Furthermore, the method may also include using the mechanical energy to drive at least one wheel. In another embodiment, the mechanical energy can drive the motor-generator to power an electric wheel motor. In one aspect of the method, the mechanical energy is used to start the engine. The method may further include supplementing the mechanical energy with engine-generated power.

The method may further include compressing gas into the flask using the turbine-compressor, for example air can be compressed into a storage vessel. In one embodiment, the turbine-compressor may be powered by the mechanical energy generated by an engine, a motor-generator, or at least one wheel. Furthermore, the motor-generator may be electrically powered by a battery or a wheel motor-generator.

The compressed gas vehicle system includes a flask for storing compressed gas connected to a turbine-compressor. In one embodiment the turbine-compressor is configured to be connected to an engine such that mechanical energy may be transferred between the turbine-compressor and the engine. In one embodiment the turbine-compressor is further configured to be connected to a motor-generator such that mechanical energy may be transferred between the turbine-compressor, engine, and motor-generator. One system may include a turbine-compressor further configured to be connected to at least one wheel such that mechanical energy may be transferred between the turbine-compressor, engine, motor-generator, and the at least one wheel. In one embodiment, the connections between the turbine-compressor, engine, motor-generator, and the at least one wheel are through a transmission. In another embodiment the connections between the turbine-compressor, engine, and motor-generator are through a clutch. In another example at least one electric wheel motor is connected electrically to the motor-generator.

The compressed gas vehicle system may also include a control unit comprising a processor connected to control the turbine-compressor, the engine, the motor-generator, and the interconnection between the turbine-compressor, the engine, and the motor-generator. In one example the processor is configured to control the turbine-compressor to decompress a stored compressed gas to generate mechanical energy, configure the connections between the turbine-compressor, engine, and motor-generator, and start the engine using the mechanical energy generated by the turbine-compressor. In another example the control unit is configured to configure the connections between the turbine-compressor, engine, motor-generator, and wheel, to drive at least one wheel.

In one embodiment the compressed gas vehicle system includes at least one electric wheel motor connected electrically to the motor-generator, and the control unit is configured to configure the connections to transfer the mechanical energy to the motor-generator, control the motor-generator to provide power to at least one electric wheel motor.

In one embodiment, the processor may further be configured to configure the connection to supply mechanical energy to the turbine-compressor from the engine, the motor-generator, or the wheel. In another embodiment the processor is configured to control the turbine-compressor to compress a gas into the flask.

Further areas of applicability of the present disclosure will become apparent from the detailed description, drawings and claims provided hereinafter. It should be understood that the detailed description, including disclosed embodiments and drawings, are merely exemplary in nature intended for purposes of illustration only and are not intended to limit the scope of the invention, its application or use. Thus, variations that do not depart from the gist of the invention are intended to be within the scope of the invention.

### BRIEF DESCRIPTION OF THE DRAWINGS

FIG. 1 is a schematic of a compressed gas vehicle system in accordance with the present disclosure;

FIG. 2 is a schematic of a compressed gas vehicle system in accordance with the present disclosure;

FIG. 3 is an energy conversion flow diagram of one embodiment of the compressed gas vehicle system of FIG. 1;

FIG. 4 is an energy conversion flow diagram of one embodiment of the compressed gas vehicle system of FIG. 1;

FIG. 5 is an energy conversion flow diagram of one embodiment of the compressed gas vehicle system of FIG. 1;

FIG. 6 is an energy conversion flow diagram of one embodiment of the compressed gas vehicle system of FIG. 2;

FIG. 7 is an energy conversion flow diagram of one embodiment of the compressed gas vehicle system of FIG. 2; and

FIG. 8 is an energy conversion flow diagram of one embodiment of the compressed gas vehicle system of FIG. 2.

### DETAILED DESCRIPTION

In one form, the present disclosure provides a method of using a compressed gas system in a vehicle using a turbine-compressor to provide power to the vehicle and restart the engine. Traditionally, internal combustion engines are started electrically. An electrified start/stop powertrain configuration may require additional electrical power for acceleration during engine restart. The electrical energy may be stored in an electrochemical cell or battery, which inherently has a limited life. A mechanical energy storage system is thus more intrinsically durable and provides additional benefits.

Thus, as described below in more detail and in accordance with the disclosed principles, mechanical energy is generated by expanding compressed gas through a turbine-compressor. The mechanical energy can then be distributed to mechanically turn the engine for restart, drive the wheels, and/or turn a motor-generator to generate electricity. Also in accordance with the disclosed principles, mechanical energy can be stored in a flask by compressing gas via the turbine-compressor. The turbine-compressor can be driven by mechanical energy supplied by the engine, by the electrically powered motor-generator, and/or by the kinetic energy of the moving vehicle via the powertrain.

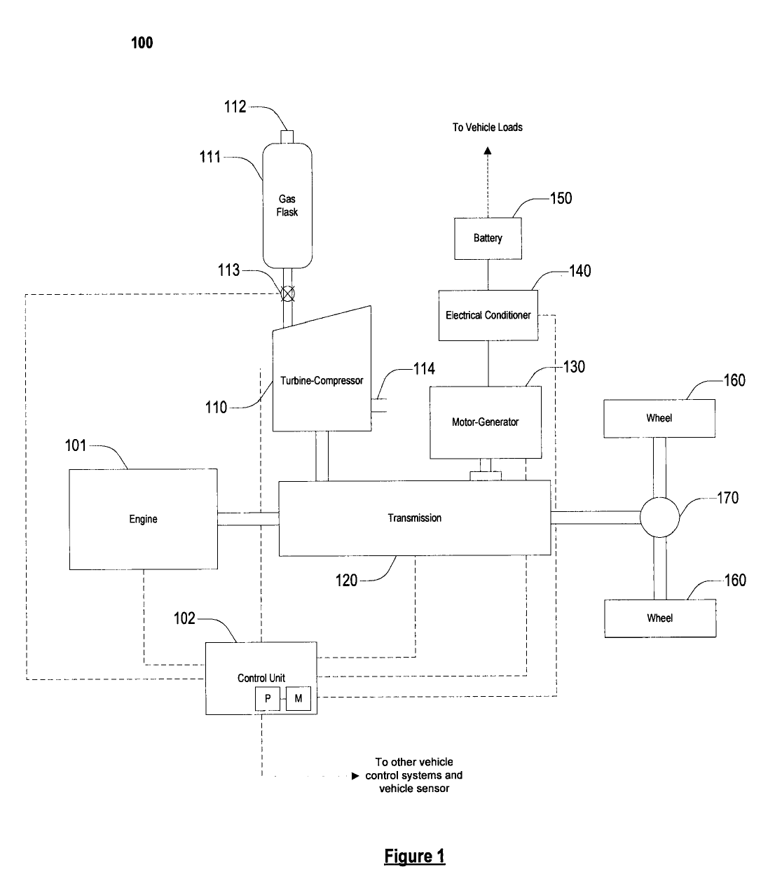

FIG. 1 illustrates an example compressed gas vehicle system 100 that comprises an engine 101, a turbine-compressor 110, and a gas flask 111. The gas flask 111 may include a pressure relief valve 112. A valve 113 may be provided between the turbine-compressor 110 and the flask 111. The turbine-compressor 110 may include a valve (not shown) on the turbine-compressor gas intake-exhaust 114. In another embodiment, there is no valve between the turbine-compressor 110 and the gas flask 111 and the release of compressed gas is controlled via a turbine brake (not shown).

In one embodiment, the turbine-compressor 110 is configured to operate in two directions. When operated as a turbine, compressed gas is released from the gas flask 111 through the turbine compressor 110 to the turbine intake-exhaust 114, generating mechanical energy. When operated as a compressor, mechanical energy is inputted into the turbine-compressor 110 causing the compression of gas from the intake-exhaust 114 into the gas flask 111.

The compressed gas vehicle system 100 may further comprise a motor-generator 130 electrically connected to an electrical conditioner 140. The electrical conditioner 140 may be configured to operate in two electrical directions. As an example, the motor-generator 130 may serve as a generator converting mechanical energy into electrical energy. The electrical conditioner 140 may then convert the electrical energy into a suitable electrical profile to charge a battery 150 or power other vehicle loads. In another example, the motor-generator 130 is a motor and the electrical conditioner 140 powers the motor-generator 130 from the energy stored in the battery 150. In an example embodiment, the electrical conditioner 140 is a traction power inverter module.

The compressed gas vehicle system 100 may further comprise two wheels 160. Although two wheels are shown, it should be understood that a single wheel, or multiple axles may also be used. The wheels 160 may be connected by a differential 170, or any other interconnection suitable for mechanical power distribution. The wheels 160, motor-generator 130, turbine-compressor 110, and engine 101 are all mechanically connected to each other via a transmission 120. The transmission 120 may be a conventional transmission suitably geared to transfer mechanical power between the wheels 160, motor-generator 130, turbine-compressor 110, and engine 101.

The compressed gas vehicle system 100 may also include a control unit 102 including a processor (P) connected to a memory (M). The control unit 102 is electrically connected to at least one of the engine 101, valve 113, turbine-compressor 110, transmission 120, motor-generator 130, or electrical conditioner 140 so as to provide control signals to the compressed gas vehicle system 100 components. The control unit 102 may also be connected to other vehicle control systems and vehicle sensors to enable the re-configuration of the compressed gas vehicle system 100 components in response to vehicle status indicators and other criteria.

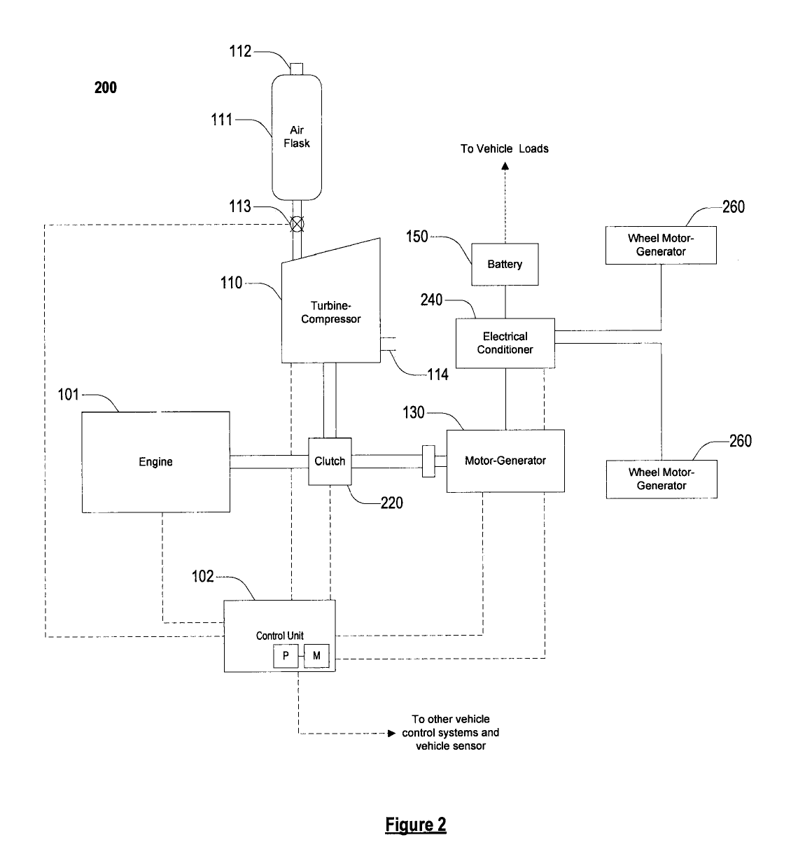

FIG. 2 illustrates an example compressed gas vehicle system 200 comprising electric wheel motor-generators 260. In one embodiment, the engine 101, turbine-compressor 110, and motor-generator 130 are connected to each other via a simple mechanical coupler capable of switching mechanical power between the engine 101, turbine-compressor 110, and motor-generator 230 in response to control signals from the control unit 102. The mechanical coupler may be a clutch 220. Unlike the compressed gas vehicle system 100 of FIG. 1, the at least one wheel motor-generator 260 (which could be an electric traction motor generator that provides mechanical energy that is ultimately provided to at least one wheel) is powered exclusively from electricity. Because the wheel motor-generators 260 are electrically driven, the transmission 120 of (FIG. 1) can be replaced with the clutch 220, which does not directly couple the transfer of mechanical energy, here from the turbine compressor 110 and/or the engine 101 and/or motor generator 130, to the at least one wheel motor-generator 260 to power the wheels. In one example, the clutch 220 has reduced components (compared to a traction transmission configuration mechanically coupled to the wheels for wheel traction) thereby significantly reducing the weight of the vehicle. Two wheel motor-generators 260 are shown, but it should be understood that a single wheel motor-generator, or more than two wheel motor-generators may also be used, for example, four wheel motor-generators. The wheel motor-generators 260 are connected to an electrical conditioner 240 which is electrically connected to the motor-generator 130 and/or a battery, whereby the motor generator may also be connected through an electrical conditioner to a battery in addition to or instead of being connected to the at least one wheel motor-generator 260. For example, a traction transmission may be configured to be capable of switching between being a traction transmission and a non-traction transmission provided at least one wheel motor-generator is present in a configuration whereby it is capable of providing traction mechanical power ultimately to at least one wheel when the otherwise traction transmission is in the state of being a non-traction transmission. Furthermore, a transmission embodiment may be one such that the additional at least one wheel motor-generator that facilitates the coupling of mechanical energy ultimately to one wheel when the powertrain is configured with a non-traction transmission is capable of providing mechanical energy ultimately to the at least one wheel in parallel with a transmission that can be switched between being a traction and non-traction transmission in the traction transmission mode, or in parallel with a purely traction transmission.

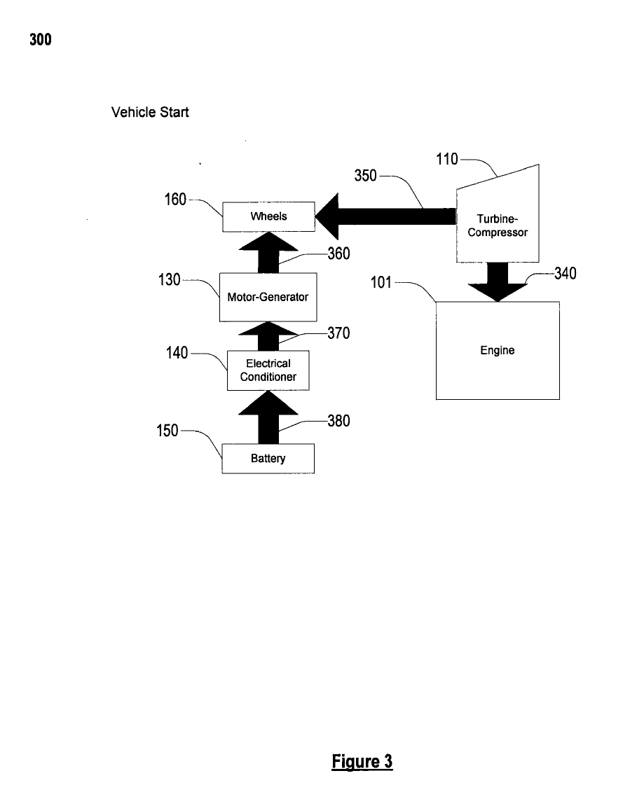

FIG. 3 illustrates an example energy flow and conversion diagram for a method 300 of using compressed gas in vehicle system 100. This flow diagram shows what happens when engine 101 is not running and gas is compressed in flask 111 (FIG. 1). Compressed gas may be released through turbine-compressor 110 generating mechanical energy. The transmission 120 (FIG. 1) may be configured such that a portion of the mechanical energy 340 may be used to mechanically start the engine 101. Another portion of the mechanical energy 350 may be used to mechanically turn the wheels 160. Depending on the state of charge of the battery 150, electrical conditioner 140 may be powered 380 by the battery 150. The electrical conditioner 140 may then electrically power 370 the motor-generator 130 to generate mechanical energy 360. The transmission 120 (FIG. 1) may be configured such that the mechanical energy 360 may also be used to mechanically turn the wheels. In one embodiment, the compressed gas vehicle system 100 is configured to turn the wheels 160 simultaneously with or before engine 101 start.

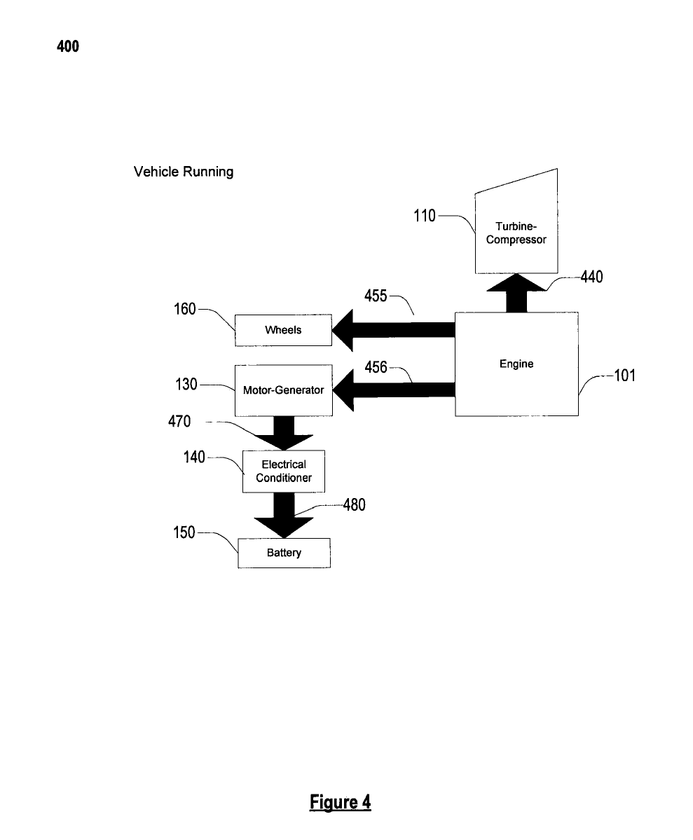

FIG. 4 illustrates an example energy flow and conversion diagram for a method 400 of using a compressed gas vehicle system 100 in a vehicle when the engine 101 is running and the gas flask 111 (FIG. 1) is not at full operating pressure. A portion of the engine 101 mechanical energy 455 may be transferred to the wheels 160 via the transmission 120 (FIG. 1). Another portion of the engine 101 mechanical energy 456 may be transferred to the motor-generator 130. Depending on the state of charge of the battery 150, motor-generator 130 may electrically power 470 the electrical conditioner 140 which may electrically charge the battery 480. The engine's 101 mechanical energy 440 may also be transferred to the turbine-compressor 110 to compress gas into the gas flask 111 (FIG. 1).

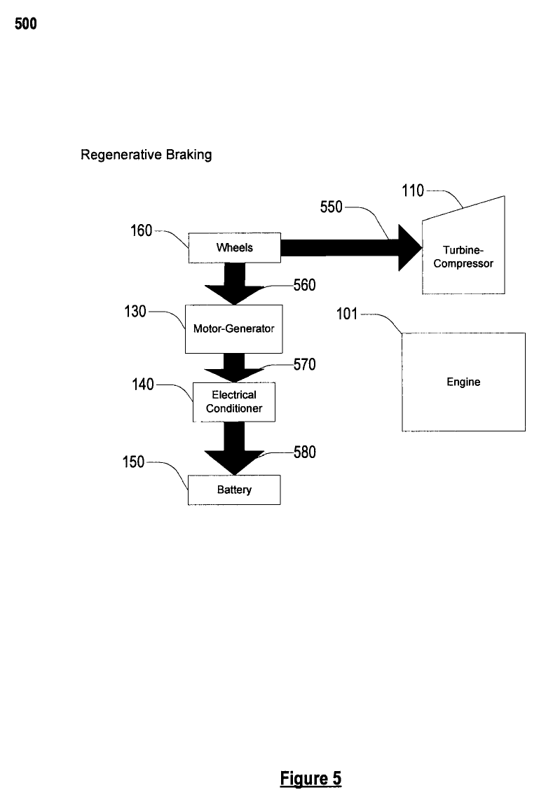

FIG. 5 illustrates an example energy flow and conversion diagram for a method 500 of using a compressed gas vehicle system 100 in a vehicle during regenerative braking (i.e., another instance where the engine 101 may be not running). For example, the engine 101 may be not running during a stop cycle during vehicle deceleration to improve fuel economy. In one embodiment, kinetic energy 560 from the wheels 160 may be used to power motor-generator 130 via the transmission 120 (FIG. 1). Depending on the state of charge of the battery 150, motor-generator 130 may electrically power 570 the electrical conditioner 140 which may electrically charge 580 the battery 150. Another portion of kinetic energy 550 from the wheels 160 may also be distributed via transmission 120 (FIG. 1) to the turbine-compressor 110 to compress gas into the gas flask 111 (FIG. 1).

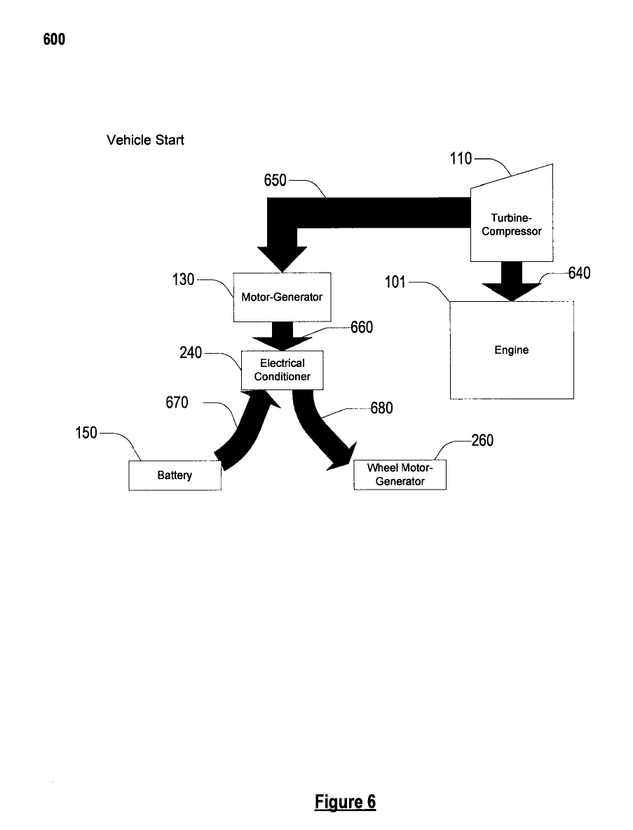

FIG. 6 illustrates an example energy flow and conversion diagram for a method 600 of using compressed gas in vehicle system 200 (FIG. 2). This flow diagram shows what happens when engine 101 is not running and gas is compressed in flask 111 (FIG. 2). Compressed gas may be released through turbine 110 generating mechanical energy. The clutch 220 (FIG. 2) may be configured such that a portion of the mechanical energy 640 may be used to mechanically start the engine 101. Another portion of the mechanical energy 650 may be used to mechanically turn the motor-generator 130. The motor-generator 130 may then electrically power 660 electrical conditioner 240. Depending on the state of charge of the battery 150, electrical conditioner 240 may also charge the battery 150 (not shown) or be powered 670 by the battery 150. In one embodiment, the electrical conditioner 240 may then drive one or several wheel motor-generators 260. In one embodiment, the compressed gas vehicle system 200 is configured to drive wheel motor generators 260 simultaneously with or before engine 101 start.

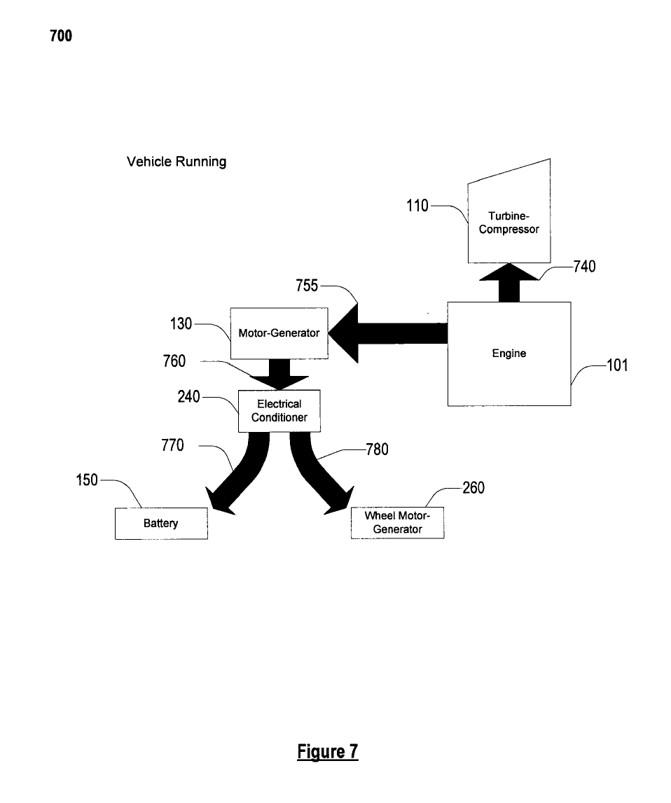

FIG. 7 illustrates an example energy flow and conversion diagram for a method 700 of using a compressed gas vehicle system 200 in a vehicle when the engine 101 is running and the gas flask 111 (FIG. 2) is not at full operating pressure. The engine 101 mechanical energy 755 may be transferred to the motor-generator 130, which electrically powers the electrical conditioner 240 and wheel motor-generator 260 as disclosed previously in reference to FIG. 6. In one embodiment, electrical output 770 from the electrical conditioner 240 may be used to charge the battery 150. The engine's 101 mechanical energy 740 may also be transferred to the turbine-compressor 110 to compress gas into the gas flask 111 (FIG. 2).

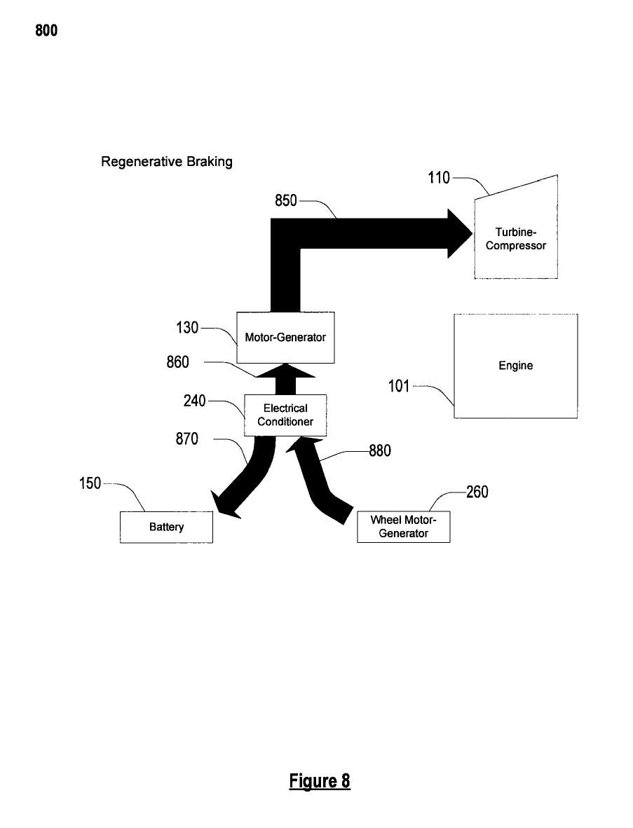

FIG. 8 illustrates an example energy flow and conversion diagram for a method 500 of using a compressed gas vehicle system 200 in a vehicle during regenerative braking (i.e., another instance where the engine 101 may be not running). For example, the engine 101 may be not running during a stop cycle during vehicle deceleration to improve fuel economy. In one embodiment, kinetic energy from the wheel motor-generator 260 may be converted into electrical energy 880 through regenerative braking. Electrical energy 880 may be used to power the electrical conditioner 270. In one embodiment, the electrical conditioner 270 is used to charge 870 the battery 150. The electrical conditioner 270 may also be used to power 560 the motor-generator as a motor to generate mechanical energy 850. Mechanical energy 850 may then be distributed to the turbine-compressor 110 to compress gas into the gas flask 111 (FIG. 2) as disclosed previously in reference to FIG. 7. Examples of contemplated systems include three inputs (engine; fluid moving a turbine; and motor) to provide mechanical energy; generators (mechanical energy operates a turbine as a pump/generator, and a motor acting as a generator); and outputs (mechanical to a wheel and electrical to a wheel). A controller may be utilized to operate combinations of the inputs, generators and outputs at any time.

As can be seen, by incorporating a compressed gas system into a vehicle, a mechanical method of energy storage is available where the storage medium is more durable as compared to traditional electrochemical cells with an intrinsic finite calendar life. Furthermore, embodiments disclosed incorporate further weight savings features allowing for fuel efficiency to be improved.

1. A method of using a compressed gas system in a vehicle, the method comprising:
generating mechanical energy by expanding stored compressed gas through a turbine-compressor; and
distributing the mechanical energy to at least one vehicle component requiring power.

2. The method of claim 1, wherein the mechanical energy is distributed via a clutch.

3. The method of claim 1, further comprising using the mechanical energy to generate electricity via a motor-generator.

4. The method of claim 1, further comprising using the mechanical energy to drive at least one wheel.

5. The method of claim 4, wherein driving at least one wheel comprises providing power to an electric wheel motor used to drive the at least one wheel.

6. The method of claim 1, further comprising using the mechanical energy to start an engine.

7. The method of claim 6, further comprising supplementing the mechanical energy with engine-generated power.

8. The method of claim 1, further comprising compressing gas into a flask using the turbine-compressor.

9. The method of claim 8, wherein the turbine compressor is powered by the mechanical energy generated by at least one of: an engine, a motor-generator, and at least one wheel.

10. The method of claim 9, wherein the motor-generator is powered by at least one of: a battery and a wheel motor-generator.

11. A compressed gas vehicle system comprising:
a flask for storing compressed gas; and
a turbine compressor connected to the flask, the turbine-compressor being configured to be connected to an engine such that mechanical energy may be transferred between the turbine-compressor and the engine.

12. The compressed gas vehicle system of claim 11, wherein the turbine-compressor is further configured to be connected to a motor-generator such that mechanical energy may be transferred between the turbine-compressor, engine, and motor-generator.

13. The compressed gas vehicle system of claim 12, wherein the turbine-compressor is further configured to be connected to at least one wheel such that mechanical energy may be transferred between the turbine-compressor, engine, motor-generator, and the at least one wheel.

14. The compressed gas vehicle system of claim 13, wherein the connections between the turbine-compressor, engine, motor-generator, and the at least one wheel wheel are through a transmission.

15. The compressed gas vehicle system of claim 12, wherein the connections between the turbine-compressor, engine, and motor-generator are through a clutch.

16. The compressed gas vehicle system of claim 12, wherein at least one electric wheel-motor is connected electrically to the motor-generator.

17. The compressed gas vehicle system of claim 12, further comprising a control unit connected to control the turbine-compressor, the engine, the motor-generator, and the connection between the turbine-compressor, engine, and motor-generator, said control unit being configured to:
control the turbine-compressor to decompress a stored compressed gas to generate mechanical energy,
configure the connections between the turbine-compressor, engine, and motor-generator, and
start the engine using the mechanical energy generated by the turbine-compressor.

18. The compressed gas vehicle system of claim 17, further comprising at least one wheel, wherein the control unit is further configured to configure the connections between the turbine-compressor, engine, motor-generator, and wheel, to drive at least one wheel.

19. The compressed gas vehicle system of claim 17, further comprising at least one electric wheel motor connected electrically to the motor-generator, wherein the control unit is further configured to:
configure the connections to transfer the mechanical energy to the motor-generator,
control the motor-generator to provide power to at least one electric wheel motor.

20. The compressed gas vehicle system of claim 12, further comprising at least one wheel and a control unit connected to control the turbine-compressor, the engine, the motor-generator, and the connection between the turbine-compressor, engine, and motor-generator, said control unit being configured to:
configure the connection to supply mechanical energy to the turbine-compressor from at least one of: the engine, the motor-generator, and the wheel, and
control the turbine-compressor to compress a gas into the flask.
